(19) United States
(12) Patent Application Publication
(10) Pub. No.: US 2022/0207621 A1
(43) Pub. Date: Jun. 30, 2022

(54) INTERACTION NEURAL NETWORK FOR PROVIDING FEEDBACK BETWEEN SEPARATE NEURAL NETWORKS

(71) Applicant: International Business Machines Corporation, Armonk, NY (US)

(72) Inventors: Jitendra Singh, Noida (IN); Seema Nagar, BANGALORE (IN); Kuntal Dey, Rampurhat (IN); Prabhat Manocha, Delhi (IN)

(21) Appl. No.: 17/136,249

(22) Filed: Dec. 29, 2020

(51) Int. Cl. G06Q 50/02; G06N 3/04; G06N 3/063; G06N 3/08

(52) U.S. Cl. CPC G06Q 50/02; G06N 3/08; G06N 3/063; G06N 3/0454

(57) ABSTRACT

A method for providing feedback between separate neural networks to predict crop yield of a polyculture by combining the crop yield predictions from the neural networks is described. The method includes configuring a set of neural networks, each neural network in the set of neural networks predicting crop yield for a respective crop from a set of crops based on a set of crop growth time series, one crop growth time series for each respective crop, the set of crops being grown in a polyculture. A crop simulator generates the set of crop growth time series based on application rates of farm inputs that are provided to the crop simulator. The method further includes determining a predicted crop yield of the polyculture at a timepoint after a predetermined duration by iteratively changing and applying application rates of farm inputs based on the crop growth time series.

### BACKGROUND

The present invention relates in general to computing technology and, more specifically, to improving neural networks that are used to predict outcomes of two or more activities when the activities are performed concurrently and with interaction with each other, as opposed to performing the two activities independently. Particularly, embodiments are discussed where an interaction layer is used between the neural networks to facilitate the output of one neural network to be used as feedback into another neural network, and the output of the other neural network is used as feedback into the first neural network.

In computing technology, a branch of machine learning, neural networks (NN), also known as artificial neural networks (ANN), includes developing and using computational models. Neural networks have a unique ability to extract meaning from imprecise or complex data to find patterns and detect trends that are too convoluted for the human brain or other computer techniques.

Neural networks find use in various real-world solutions such as computer vision, speech recognition, automated driving, space exploration, traffic prediction, weather prediction, etc. Among these several applications for which neural networks are used, one is crop yield prediction. Predicting a crop's yield can be extremely challenging due to its dependence on multiple factors such as crop genotype, environmental factors, management practices, and their interactions. Several computing solutions have been developed to estimate a crop's yield prediction using neural networks, such as using convolutional neural networks (CNNs), recurrent neural networks (RNNs), random forest (RF), deep fully connected neural networks (DFNN), and the like.

### SUMMARY

According to one or more embodiments of the present invention, a computer-implemented method for providing feedback between separate neural networks, particularly to address a technical challenge with polycultures is described. The method includes configuring a set of neural networks, each neural network in the set of neural networks predicting crop yield for a respective crop from a set of crops based on a set of crop growth time series, one crop growth time series for each respective crop, the set of crops being grown in a polyculture. The method further includes generating, by a crop simulator, the set of crop growth time series based on application rates of farm inputs that are provided to the crop simulator. The method further includes determining a predicted crop yield of the polyculture at a timepoint after a predetermined duration by iteratively performing the further steps for a predetermined number of times. The iterated steps include computing, by an interaction layer, changes to the application rates of farm inputs based on the set of crop growth time series. The iterated steps also include applying the changes to the application rates of farm inputs and recomputing the set of crop growth time series, the application rates of farm inputs causing an interaction between the crop growth time series for each respective crop. The method further includes predicting the crop yield for each respective crop by the neural networks using the set of crop growth time series that are recomputed causing an interaction between the crop yields. The method further includes outputting the predicted crop yield of the polyculture by combining the crop yield predictions from each of the neural networks.

According to one or more embodiments of the present invention, a system includes a memory device, and one or more processing units coupled with the memory device that perform a method to address a technical challenge with polycultures. The method includes configuring a set of neural networks, each neural network in the set of neural networks predicting crop yield for a respective crop from a set of crops based on a set of crop growth time series, one crop growth time series for each respective crop, the set of crops being grown in a polyculture. The method further includes generating, by a crop simulator, the set of crop growth time series based on application rates of farm inputs that are provided to the crop simulator. The method further includes determining a predicted crop yield of the polyculture at a timepoint after a predetermined duration by iteratively performing the further steps for a predetermined number of times. The iterated steps include computing, by an interaction layer, changes to the application rates of farm inputs based on the set of crop growth time series. The iterated steps also include applying the changes to the application rates of farm inputs and recomputing the set of crop growth time series, the application rates of farm inputs causing an interaction between the crop growth time series for each respective crop. The method further includes predicting the crop yield for each respective crop by the neural networks using the set of crop growth time series that are recomputed causing an interaction between the crop yields. The method further includes outputting the predicted crop yield of the polyculture by combining the crop yield predictions from each of the neural networks.

According to one or more embodiments of the present invention, a computer program product includes a computer-readable storage media having computer-executable instructions stored thereupon, which when executed by a processor cause the processor to perform a method to address a technical challenge with polycultures. The method includes configuring a set of neural networks, each neural network in the set of neural networks predicting crop yield for a respective crop from a set of crops based on a set of crop growth time series, one crop growth time series for each respective crop, the set of crops being grown in a polyculture. The method further includes generating, by a crop simulator, the set of crop growth time series based on application rates of farm inputs that are provided to the crop simulator. The method further includes determining a predicted crop yield of the polyculture at a timepoint after a predetermined duration by iteratively performing the further steps for a predetermined number of times. The iterated steps include computing, by an interaction layer, changes to the application rates of farm inputs based on the set of crop growth time series. The iterated steps also include applying the changes to the application rates of farm inputs and recomputing the set of crop growth time series, the application rates of farm inputs causing an interaction between the crop growth time series for each respective crop. The method further includes predicting the crop yield for each respective crop by the neural networks using the set of crop growth time series that are recomputed causing an interaction between the crop yields. The method further includes outputting the predicted crop yield of the polyculture by combining the crop yield predictions from each of the neural networks.

In one or more embodiments of the present invention, the interaction layer is another neural network. In one or more embodiments of the present invention, the interaction layer is a recurrent neural network.

In one or more embodiments of the present invention, each neural network in the set of neural networks is a recurrent neural network.

In one or more embodiments of the present invention, the predetermined duration is divided into a plurality of time periods, wherein the crop simulator generates the crop growth time series for a time period, and the interaction layer computes the changes to the application rates of farm inputs for a sequentially subsequent time period.

In one or more embodiments of the present invention, the farm inputs include at least one of water, fertilizer, and pesticide.

In one or more embodiments of the present invention, the method further includes outputting a harvest date advisory for each crop from the plurality of crops.

Additional technical features and benefits are realized through the techniques of the present invention. Embodiments and aspects of the invention are described in detail herein and are considered a part of the claimed subject matter. For a better understanding, refer to the detailed description and the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a diagram of an example neural network;

FIG. 2A is a diagram of an example general recurrent neural network (RNN) block;

FIG. 2B is a diagram of an example general RNN block;

FIG. 3 is a diagram of an example long short-term memory (LSTM) RNN block;

FIG. 4 depicts a block diagram of a neural network system with an interaction layer according to one or more embodiments of the present invention;

FIG. 5 depicts a flowchart of a method for crop simulation according to one or more embodiments of the present invention;

FIG. 6 depicts a block diagram and operational flow for training the interaction layer according to one or more embodiments of the present invention;

FIG. 7 depicts a block diagram and operational flow for using a trained interaction layer for polyculture simulation according to one or more embodiments of the present invention;

FIG. 8 depicts a flowchart of a method for predicting the yield of multiple crops in a polyculture setting using an interaction layer according to one or more embodiments of the present invention; and

FIG. 9 depicts a computer system that may be used in one or more embodiments of the present invention.

The diagrams depicted herein are illustrative. There can be many variations to the diagrams or the operations described herein without departing from the spirit of the invention. For instance, the actions can be performed in a differing order, or actions can be added, deleted, or modified. Also, the term “coupled,” and variations thereof describe having a communications path between two elements and does not imply a direct connection between the elements with no intervening elements/connections between them. All of these variations are considered a part of the specification.

### DETAILED DESCRIPTION

Embodiments of the present invention facilitate an interaction layer to be used between several neural networks to facilitate using the output of one neural network as feedback into another neural network, and the output of the other neural network to be used as feedback into the first neural network. Embodiments of the present invention are described in the context of crop yield prediction, particularly, yield estimation of a farm in inter-cropping (mixed) cropping scenario. As noted herein, predicting a crop's yield can be extremely challenging due to its dependence on multiple factors such as crop genotype, environmental factors, management practices, and their interactions. Several computing solutions have been developed to estimate a crop's yield prediction using neural networks, such as using convolutional neural networks (CNNs), recurrent neural networks (RNNs), random forest (RF), deep fully connected neural networks (DFNN), and the like. However, existing models operate in a monoculture agricultural environment, i.e., where a single species (crop) is being grown and modeled, i.e., predicted.

A “polyculture” is a form of agriculture in which more than one species is grown at the same time and place in imitation of the diversity of natural ecosystems. Whereas, in monoculture, plants of only a single species are cultivated together. Polyculture has traditionally been the most prevalent form of agriculture in most parts of the world and is growing in popularity today due to its environmental and health benefits. There are many types of polyculture. Types of polyculture include annual polycultures such as intercropping and cover cropping. Types of polyculture also include permaculture, and integrated aquaculture. Polyculture is advantageous because of its ability to control pests, weeds, and disease without major chemical inputs. As such, polyculture is considered a sustainable form of agriculture.

Unlike monoculture, there are no existing methods and systems available for estimating yield for each crop in mixed cropping. One of the reasons for the lack of such techniques includes the inability to remotely sense crop signatures because of mixed reflectance signature from multiple crops. Additionally, the existing state-of-the-art crop simulation models can only simulate single crops and can estimate/forecast yields, crop growth stages, and parameters.

Technical challenges that exist with the presently available crop yield prediction systems are addressed by technical solutions provided by embodiments of the present invention. Embodiments of the present invention provide such technical solutions by facilitating an interaction layer between two or more neural networks, where each neural network provides an output for a specific crop from among a set of crops being grown in a polyculture environment. It should be noted that embodiments of the present invention are not limited to crop yield prediction systems only, although, those are the examples described herein. Embodiments of the present invention can be used in any other prediction system where a set of neural networks are used to predict outcomes of a set of activities, where each neural network predicts an output of an individual activity based on a simulation model of that activity.

One or more embodiments of the present invention facilitate estimating crop yield in mixed crop scenarios by simulating the effect of a crop with another by an interaction layer. The interaction layer captures the interaction of a model being used by one neural network with another model being used by another neural network. In the polyculture example, the interaction layer facilitates capturing the interaction of one crop with another, and in turn, helps to capture the impact of one crop on another. Interaction between crops is important to estimate yields realistically as the requirements in terms of water, fertilizer, pesticide, and other inputs for each crop can vary significantly. In some crop combinations, such as mustard and wheat, one crop benefits from the other crop, for example, one crop acts as a source and other as a sink. It is understood that in other embodiments of the present invention, a different combination of crops is possible, with the number of crops being more than two.

In one or more embodiments of the present invention, the interaction layer facilitates using the output from one neural network to use as settings to tune the other neural network. The neural network systems can be recurrent neural network (RNN) systems in one or more embodiments of the present invention. In such cases, for every crop, the system uses a pre-trained RNN model to estimate the yield of the crop. The RNN can be implemented using conditional random fields (CRF), Long short-term memory (LSTM), or any other architecture. It is understood that although embodiments of the present invention are described herein using RNN systems, other types of neural network systems can be used in other embodiments of the present invention. For example, in other embodiments of the present invention, CNNs, or any other type of neural network systems can be used.

An RNN is a type of artificial neural network in which connections among units form a directed cycle. The RNN has an internal state that allows the network to exhibit dynamic temporal behavior. Unlike feed-forward neural networks, for instance, RNNs can use their internal memory to process arbitrary sequences of inputs. An LSTM RNN further includes LSTM units, instead of or in addition to standard neural network units. An LSTM unit, or block, is a “smart” unit that can remember, or store, a value for an arbitrary length of time. An LSTM block contains gates that determine when its input is significant enough to remember, when it should continue to remember or forget the value, and when it should output the value.

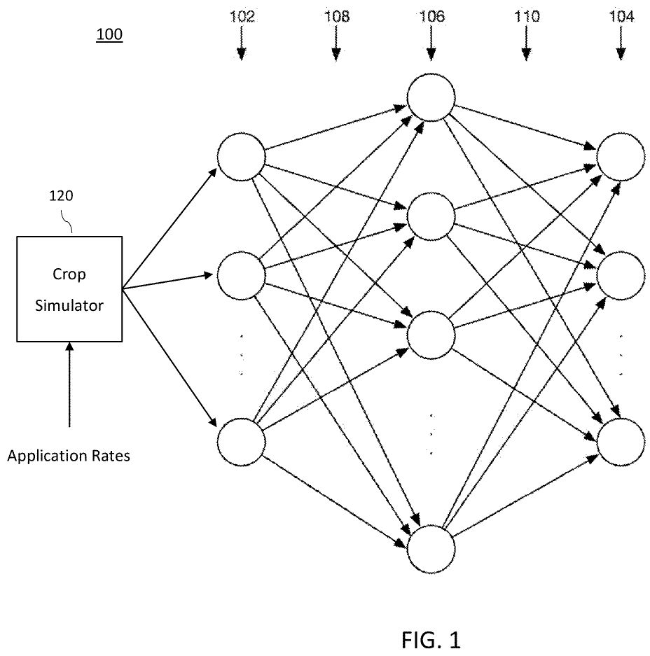

FIGS. 1, 2A, 2B, and 3 provide an overview of a neural network 100, an RNN block 200, and an LSTM RNN block 300, respectively. Referring initially to FIG. 1, an example of a neural network 100 is shown. The neural network 100 includes input nodes, blocks, or units 102; output nodes, blocks, or units 104; and hidden nodes, blocks, or units 104. The input nodes 102 are connected to the hidden nodes 106 via connections 108, and the hidden nodes 106 are connected to the output nodes 104 via connections 110.

The input nodes 102 correspond to input data, whereas the output nodes 104 correspond to output data as a function of the input data. For instance, the input nodes 102 can correspond to crop-modeling data such as time series of observed farm inputs, such as application rates of water, nutrients, insecticides, fertilizers, and any other inputs given to the crops. The application rates of the farm inputs (e.g., water, nutrients, etc.) are homogeneous for each participant crop in the mixed-cropping scenario. It should be noted that highly heterogenous application rates for the various crops would make the scenario similar to monoculture. In one or more embodiments of the present invention, the input data can be a computer-generated time series from a crop simulator 120 for each crop. For example, the crop simulator 120 can generate crop growth parameters such as leaf area index, root depth, plant height, etc., for the respective participating crops in the mixed cropping scenario, one time series per crop. The crop simulator 120 for each crop uses application rates of the farm inputs for that crop as an input to generate the output time series for the said crop. The crop simulator 120 generates the time series for a predetermined duration of time, such as one day, one week, two weeks, a month, and any other number of days or periods of time.

The output nodes 104 can correspond to crop yield predictions for the respective crops given the output from the crop simulator 120. The output is generated based on the model that is being used by the RNN 100. The RNN 100, for each crop, learns the time series of weights or transfer functions which are to be used to update the application rates to run the crop simulator 120 for a subsequent period of time, for example, for the next week, the next two weeks, and so on.

The nodes 106 are hidden nodes, and the neural network 100 itself generates the nodes 106. Just one layer of hidden nodes 106 is depicted, but it is understood that there can be more than one layer of hidden nodes 106.

To construct the neural network 100, training data in the form of input data that has been manually or otherwise already mapped to output data is provided to a neural network model, which generates the network 100. The model thus generates the hidden nodes 106, weights of the connections 110 between the input nodes 102 and the hidden nodes 106, weights of the connections 110 between the hidden nodes 106 and the output nodes, and weights of connections between layers of the hidden nodes 106 themselves. After that, the neural network 100 can be employed against input data for which output data is unknown to generate the desired output data. For example, in the case where the neural network 100 is an RNN, the RNN learns the weights by factoring in time series histories, in the process of updating learning the parameter weights (transfer function). As noted earlier, an RNN is one type of neural network. Other neural networks may not store any intermediary data while processing input data to generate output data. By comparison, an RNN does persist data, which can improve its classification ability over other neural networks that do not. “Generating” the neural network 100 can also be referred to as training the neural network 100.

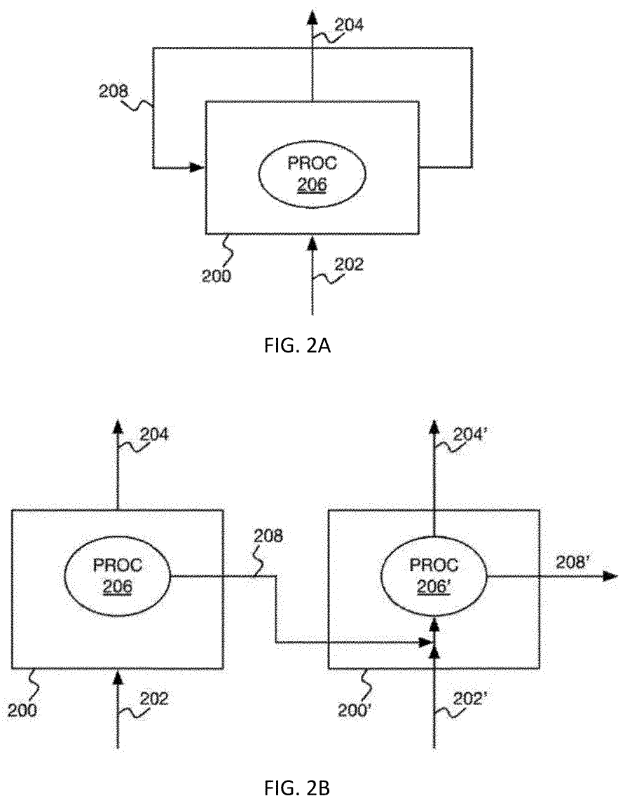

FIG. 2A shows a compact notation of an example RNN block 200, which typifies a hidden node 106 of a neural network 100 that is an RNN. The RNN block 200 has an input connection 202, which may be a connection 108 of FIG. 1 that leads from one of the input nodes 102, or which may be a connection that leads from another hidden node 106. The RNN block 200 likewise has an output connection 204, which may be a connection 110 of FIG. 1 that leads to one of the output nodes 104, or which may be a connection that leads to another hidden node 106.

The RNN block 200 generally is said to including processing 206 that is performed on (at least) the information provided on the input connection 202 to yield the information provided on the output connection 204. The processing 206 is typically in the form of a function. For instance, the function may be an identity activation function, mapping the output connection 204 to the input connection 202. The function may be a sigmoid activation function, such as a logistic sigmoid function, which can output a value that is within the range (0, 1) based on the input connection 202. The function may be a hyperbolic tangent function, such as a hyperbolic logistic tangent function, which can output a value that is within the range (−1, 1) based on the input connection 202. Any other activation function can be used in one or more embodiments of the present invention.

The RNN block 200 also has a temporal loop connection 208 that leads back to a temporal successor of itself. The connection 208 is what renders the block 200 recurrent, and the presence of such loops within multiple nodes is what renders the neural network 100 “recurrent.” The information that the RNN block 200 outputs on the connection 204 (or other information), therefore, can persist on the connection 208. On this basis, new information received on the connection 202 can be processed. That is, the information that the RNN block 200 outputs on the connection 204 is merged or concatenated, with information that the RNN block 200 next receives on the input connection 202, and subsequently processed via the processing 206.

FIG. 2B shows an expanded notation of the RNN block 200. The RNN block 200′ and the connections 202′, 204′, 206′, 208′ have the same structure and functionality as the RNN block 200 and the connections 202, 204, 206, 208, but at a temporally later time. In other words, the RNN block 200′ is another instance of the RNN block 200. FIG. 2B thus better illustrates that the RNN block 200′ at the later time receives the information provided on the connection 206 provided by the (same) RNN block 200 at an earlier time. The RNN block 200′ at the later time can provide information to itself at an even later time on the connection 206′.

An LSTM RNN is one type of RNN. A general RNN can persist information over both the short term and the long term. However, in practice, such RNNs may have difficulty persisting information over the long term. In other words, a general RNN may have difficulty learning long-term dependencies, which means that the RNN can have difficulty processing information based on information that it previously processed a relatively long time earlier. Here, a “long time” can be at least 2 hidden nodes earlier. By comparison, an LSTM RNN is a specific type of RNN that provides improved learning over long-term dependencies, and therefore a type of RNN that can better persist information over a long time.

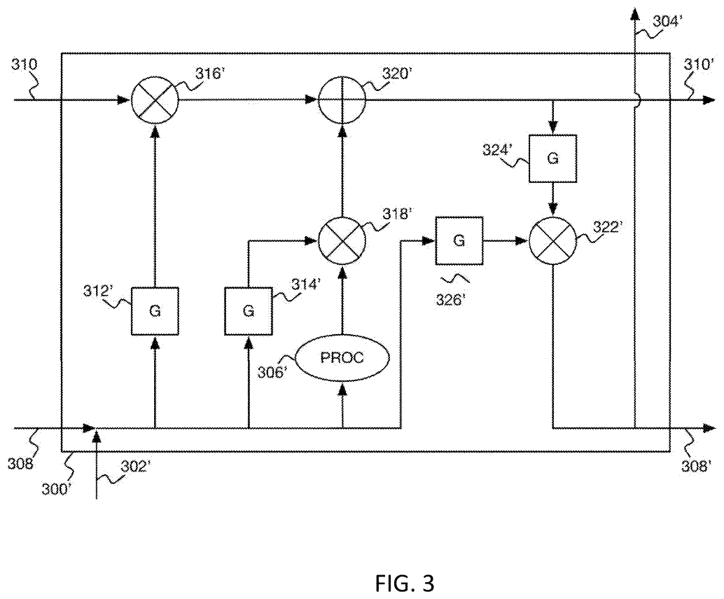

FIG. 3 shows an example of LSTM RNN block 300′. The LSTM RNN block 300′ has an input connection 302′, an output connection 304′, and processing 306′, comparable to the connections 202/202′ and 204/204′, and processing 206/206′ of the RNN block 200/200′ of FIGS. 2A and 2B. However, rather than having a single temporal loop connection 208/208′ that connects temporal instances of the RNN block 200/200′, the LSTM RNN block 300′ has two temporal loop connections 308′ and 310′ over which information persists among temporal instances of the LSTM RNN block 300.

The information on the input connection 302′ is merged with the persistent information provided on the connection 308 from a prior temporal instance of the LSTM RNN block and undergoes the processing 306′. How the result of the processing 306′ is combined, if at all, with the persistent information provided on the connection 310 from the prior temporal instance of the LSTM RNN block is controlled via gates 312′ and 314′. The gate 312′, operating based on the merged information of the connections 302′ and 308, controls an element-wise product operator 316′, permitting the persistent information on the connection 310 to pass (or not). The gate 314′, operating on the same basis, controls an element-wise operator 318′ permitting of the output of the processing 306′ to pass (or not).

The outputs of the operators 316′ and 318′ are summed via an addition operator 320′. The result is passed as the persistent information on the connection 310′ of the current instance of the LSTM RNN block 300′. Therefore, the extent to which the persistent information on the connection 310′ reflects the persistent information on the connection 310 and the extent to which this information on the connection 310′ reflects the output of the processing 306′ is controlled by the gates 312′ and 314′. As such, information can persist across or over multiple temporal instances of the LSTM RNN block as configured.

The output of the depicted instance of the LSTM RNN block 300′ is itself provided on the connection 304′ to the next layer of the RNN and also persists to the next temporal instance of the LSTM RNN block on connection 308′. This output is provided by another element-wise product operator 322′. It passes a combination of the information that is also provided on the connection 310′. The merged information on the connections 302′ and 308 are controlled by the gates 324′ and 326′, respectively. In this way, then, the LSTM RNN block 300′ of FIG. 3 can persist both long-term as well as short-term information, whereas the RNN block 200/200′ of FIGS. 2A and 2B has difficulty learning long-term dependencies.

It should be noted that the neural network 100 provides crop yield prediction for a single crop given the time-series from the crop simulator 120 as input. Further, it is understood that although the crop simulator 120 is depicted to provide the time-series, in one or more embodiments of the present invention, the time-series can be input from other sources, such as manual input.

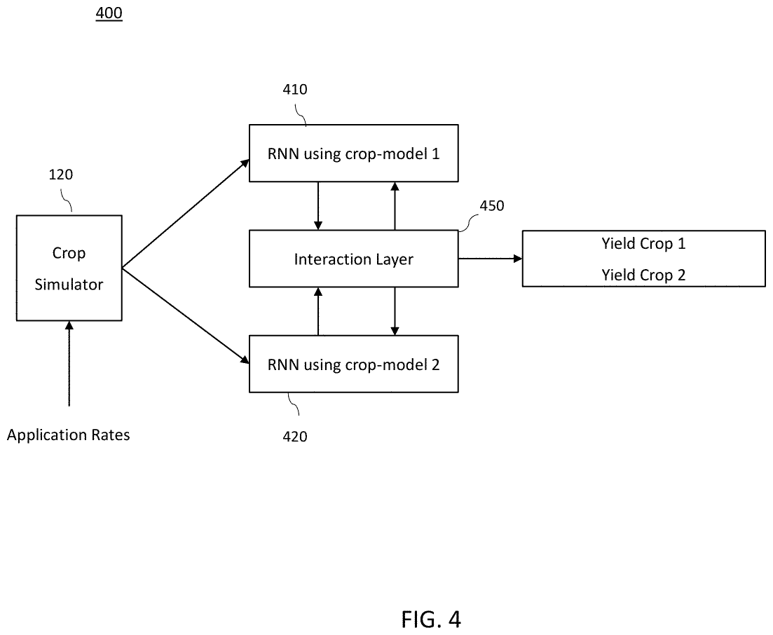

FIG. 4 depicts a block diagram of a neural network system with an interaction layer according to one or more embodiments of the present invention. The neural network system 400 can provide crop yield production for multiple crops given the multiple time-series for each of the crops from the crop simulator 120. The neural network system 400 includes a first RNN 410 for predicting the yield of a first crop. The yield of the first crop is predicted using a crop-model 1 of the first crop. The first RNN 410 is trained using crop-model 1 using known techniques.

The neural network system 400 further includes a second RNN 420 for predicting the yield of a second crop. The second crop is cultivated with the first crop in a polyculture environment, i.e., a mixed crop environment where the first crop and the second crop are different crops being grown concurrently in the same field. The yield of the second crop is predicted using a crop-model 2 of the second crop. The second RNN 420 is trained using crop-model 2 using known techniques.

It is understood that although FIG. 4 shows a polyculture with only two crops, which are modeled by the first RNN 410 and the second RNN 420, in other embodiments, the polyculture can include any number of crops. The input to the first RNN 410 and the second RNN 420 include time-series of observations of the crop growth. The time-series can be the output from the crop simulator 120 in one or more embodiments of the present invention.

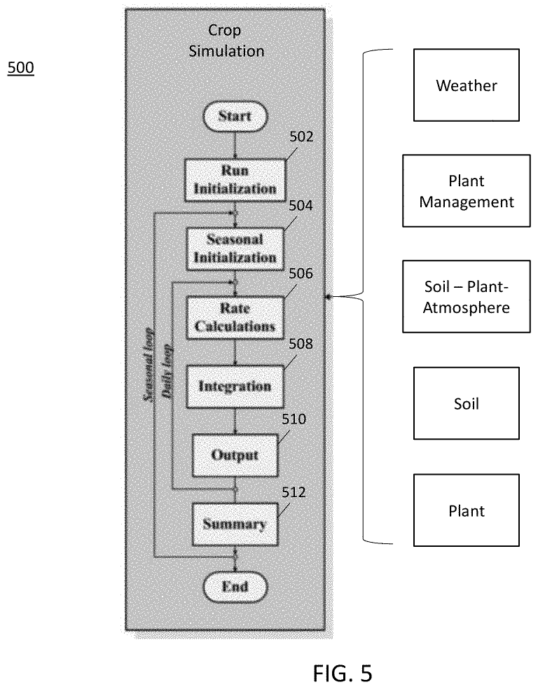

FIG. 5 depicts a flowchart of a method for crop simulation according to one or more embodiments of the present invention. Crop simulation 500 includes generating crop growth time-series based on farm inputs of application rates. The crop simulation 500 includes initializing the simulation using one or more simulation models, at block 502. For example, the initialization can include selecting a simulation model from a set of possible simulation models. The initialization can further include configuring the duration for which the crop growth time-series is to be generated by the crop simulator 120. Further, the simulation models are adjusted according to the seasonality parameters, at block 504. The seasonality parameters represent farm inputs based on the season during which the crop is being harvested.

Further, the crop simulation includes receiving one or more farm inputs, including application rates of one or more treatments, at block 506. The farm inputs can include weather forecasts and remote sensing data indicating weather for the configured time duration. The farm inputs can further include plant management data that includes sowing dates, irrigation data, fertilizer type, and application dates, tillage, planned harvest date, and other such management data. Further yet, the farm inputs can include soil and plant-atmosphere conditions. Such conditions can include soil temperature, vaporization, and other such details that can facilitate determining moisture retention and other characteristics of the soil. The farm inputs can further include soil characteristics such as N-value, P-value, organic matter, soil-water, and other such soil dynamics and other attributes of the soil that can affect crop growth. The farm inputs that are received for the crop simulation 500 can further include the type of the plant being simulated. The type of plant can include specifics of the breed, the seed, pest resistance, and other such attributes of the plant itself that can affect crop growth. The farm inputs thus include, along with the natural attributes of the weather, soil, plant species, etc., one or more application rates of plant management items such as fertilizers, insecticide, water, and other such controllable attributes.

The crop simulation 500 further includes integrating the received farm inputs to simulate the crop growth for a period of time, such as in a day, at block 508. The crop simulator 120 iterates the farm inputs and simulation for each period repeatedly to generate an output for the configured duration, such as fifteen days, etc., at block 510. The output is provided to the neural network 100, at block 512.

The crop simulator 120 can perform such crop simulations for each of the multiple crops in the polyculture. The output of the simulation for the first crop is provided to the first RNN 410. The output for the second crop is provided to the second RNN 420.

Referring to FIG. 4, the interaction layer 450 updates the application rates of the farm inputs for each period simulated by the crop simulator 120 (step 506). The application rates are updated for each crop being simulated, i.e., the first crop and the second crop. For example, the application rates can be updated for water, nutrients, fertilizers, pesticide, etc. The updated application rates are subsequently used for the crop simulation 500 for that period, which is further accounted for in the time-series. The interaction layer updates the application rates for each period in the configured duration for the simulation in this manner.

The interaction layer 450 is a neural network, such as an RNN, that is a collection of transfer functions that provide feedback to the neural networks corresponding to the crops in the polyculture. The output of the interaction layer 450 includes the application rates for the several farm inputs applied to the crops in the polyculture being modeled by the neural network system 400. For example, the farm inputs include moisture (water), soil nutrients (fertilizers), transpiration, pesticides, and other inputs given to the crops for their growth. The requirements of the farm inputs for the crops in the polyculture can be different. For example, in the example with the two crops, consider that the first crop and the second crop require X and Y liters of water per day, respectively, and that the proportion of area covered by these crops is 2:1. Accordingly, the water requirement for both crops in this situation is 2X+Y−Z liters per day. Here, Z accounts for an overlap between the water absorbed by the crops. In other words, Z would have been extra water that might have been required had the two crops planted separately (in monocultures). Further, the total plant available water for the next day would then be [Total water−(2X+Y−Z)], which would be used in crop model simulations for the next day by the crop simulator 120.

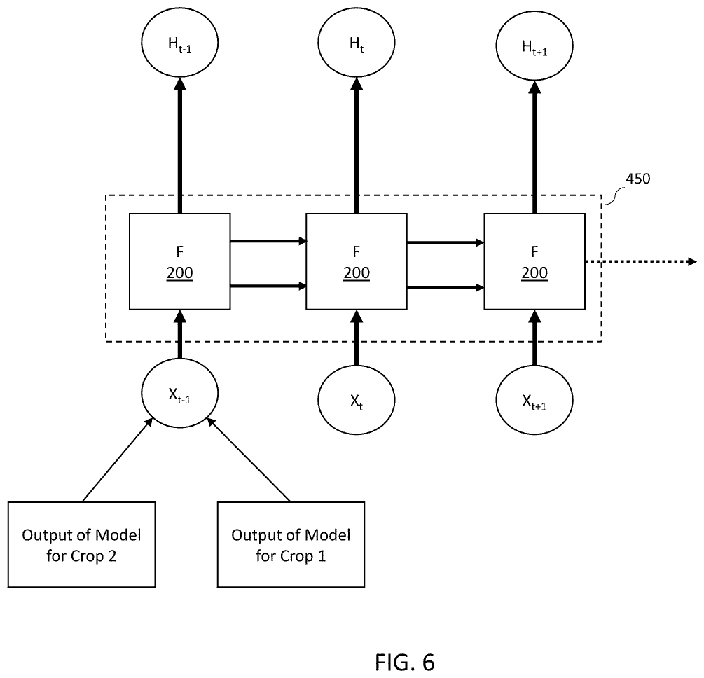

FIG. 6 depicts a block diagram and operational flow for training the interaction layer according to one or more embodiments of the present invention. The interaction layer 450 is depicted as an RNN with several instances of the node 200. Each node 200 has an activation function F that is to be trained. Each instance of node 200 passes its output to the next instance of the node 200 as depicted. Each node analyzes data at a particular time period. For example, a first node analyzes information Xₜ₋₁, passes its output to a second node that analyzes information Xₜ, which in turn passes its output to a third node that analyzes information Xₜ₊₁. Here, the suffixes denote specific time periods in the duration for which the yield is being predicted.

The information ( . . . , Xₜ₋₁, Xₜ, Xₜ₊₁, . . . ) is a vector of application rates that are passed as training data to the RNN that is the interaction layer 450. Here, the training data includes vectors of application rates for the crops in the polyculture that is being modeled by the neural network system 400. In the case of the example herein, with a polyculture of two crops, the training data includes application rates at the various time periods for both, the first crop and the second crop.

Accordingly, during the training, the interaction layer 450 receives as input the training data, which includes time-series of application rates and crop growth parameters such as leaf area index, root depth, plant height, etc. in a polyculture cropping scenario. The crop growth time-series in the training data include a time-series for the respective crops in the polyculture, one time series per crop.

The RNN, based on such training data, iteratively updates the simulations of the crops in the polyculture. The simulations are updated by adjusting the one or more application rates being used by the crop simulator 120. The training of the RNN is complete when the updated application rates result in substantially the same time-series of crop growth data.

The output of the interaction layer includes multiple time-series H of changes in application rates, one time-series per crop in the polyculture cropping. For example, the time-series H can be represented as ( . . . , Hₜ₋₁, Hₜ, Hₜ₊₁, . . . ) where Hₜ represents a change in application rate for time period t. Further, the time-series H includes changes to the application rates of the first crop as well as to the application rates of the second crop. In other words, at each time step t, the interaction layer 450 gets application rates input from the simulations for the first crop and the second crop. It is trained to adjust the application rates based on the activation functions.

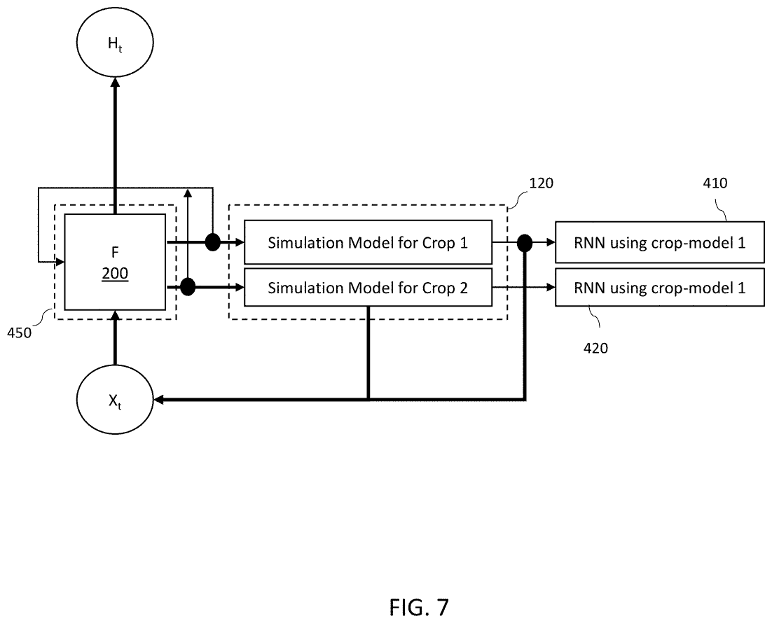

FIG. 7 depicts a block diagram and operational flow for using a trained interaction layer for polyculture simulation according to one or more embodiments of the present invention. A single node 200 of the interaction layer 450 is depicted; however, it is understood that the interaction layer 450 can include additional instances of node 200 that perform the same operations described herein. As noted earlier, each instance of node 200 can operate on determining output at a specific time period, for example, a particular day, a particular week, etc.

As shown in FIG. 7, node 200 of the interaction layer 450 receives output from the first RNN 410 and the second RNN 420. In one or more embodiments of the present invention, the first RNN 410 generates its output based on the simulation of the first crop by the simulator 120. The simulator 120, in this case, provides the crop growth time-series for the first crop.

Further, the second RNN 420 generates its output based on the simulation of the second crop by the simulator 120. The simulator 120, in this case, provides the crop growth time-series for the second crop.

The simulator 120 generates the crop growth data for the first crop and the second crop based on the various farm inputs. One of the farm inputs is the application rates of one or more farm inputs, including water, fertilizer, pesticide, and other such items. The interaction layer 450 provides the application rates for simulating the crop growth of the first crop and for simulating the crop growth of the second crop. The interaction layer 450 provides the application rates for each time period over the duration being simulated.

The output from the interaction layer 450 is accordingly provided as feedback into the first RNN 410 and the second RNN 420 for generating crop growth data for the subsequent time period, for example, the next day. The crop growth data of the subsequent time period is again input into the interaction layer, to generate another set of the application rates for the simulator 120. This process is iteratively performed for the entire duration for which the crop yield is to be predicted.

The final output (yield) from each of the first RNN 410 and the second RNN 420 are combined to predict the yield in the polyculture crop setting. The crop yield can be predicted in various units depending on the crop that is being modeled, for example, in tons/hectare, bushels/hectare, or any other unit used to express the crop yield.

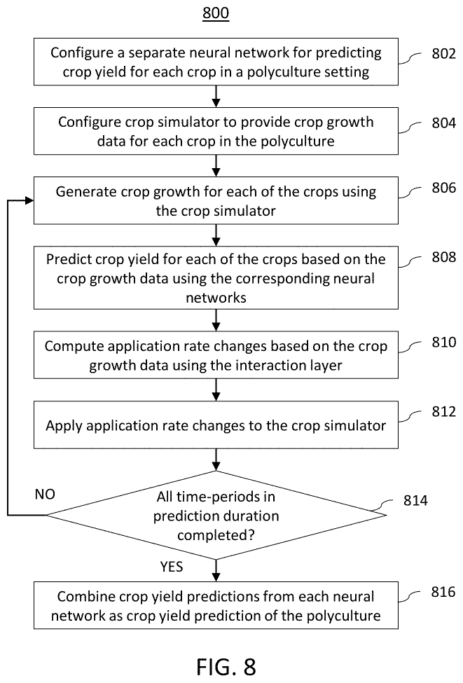

FIG. 8 depicts a flowchart of a method for predicting the yield of multiple crops in a polyculture setting using an interaction layer according to one or more embodiments of the present invention. The depicted method 800 includes configuring a separate neural network for predicting the yield of each crop in the polyculture, at block 802. The neural network can be an RNN. Configuring the neural network includes initializing the neural network to use activation functions and other parameters associated with a crop model of a crop for which the yield is being predicted by that neural network. The total number of neural networks configured equals the number of crops in the polyculture.

The crop simulator 120 is set up to generate crop growth data for each crop in the polyculture setting, at block 804. Configuring the crop simulator 120 includes providing one or more farm input parameters for each of the crops to the crop simulator. The farm input parameters include the data for weather, soil, plant management, plant, soil-plant-atmosphere, and other such parameters. These inputs include application rates for the items such as water, fertilizer, pesticide, and other such items that are provided to the crops for aiding sustenance and growth of the crops.

For each time period, the crop simulator generates crop growth data for each crop for that time period, which is provided to the corresponding neural networks that are associated with the respective crop, at block 806. Each neural network for the respective crop predicts the crop yield for that crop based on the crop growth data, at block 808.

The interaction layer 450 receives the output from the crop simulator 120 and generates changes to the application rates that are used by the crop simulator 120, at block 810. The changes to the application rates are for simulating a subsequent time period. The method 800 includes applying the changed application rates from the interaction layer to the crop simulator 120 as input, at block 812.

The method 800 further includes checking if all of the time periods in the duration for which the crop yield is to be predicted have been simulated, at block 814. The process is thus iterated for a predetermined number of times to cover the prediction duration. For example, the duration for which the crop yield is to be predicted can be six months, and a time period can be a day, a week, or any other time period. It is understood that the duration for the crop yield and the time periods can be different in various embodiments of the present invention.

The steps of generating the crop growth data and predicting the crop yield with changed application rates are iteratively performed until all of the time periods have been simulated. Once all of the time periods have been simulated, the output from each of the neural networks is combined to generate the output of the polyculture, at block 816.

In one or more embodiments of the present invention, the method 800 further includes continuing to iterate the process until a maximum crop yield is identified. The maximum crop yield can be identified when a difference between two successive predictions of crop yield is below a predetermined threshold. Once the maximum crop yield is identified, a corresponding date can be determined based on a number of iterations, each iteration being a time period of known duration. The date can be output as a harvest date. In one or more embodiments of the present invention, separate harvest dates for each crop from the polyculture can be determined in this manner by monitoring for the maximum crop yield for each of the crops.

Accordingly, in the two-crop polyculture described herein, using the method 800, at each time step t, the trained RNN model takes input (application rates) from the simulator for the first crop and the second crop. At each time step t, the crop simulator 120 produces crop growth data as output for change in the application rates. Output at each step t is fed to the neural networks as well as to the crop simulator. The crop simulator 120 ensures that output produced for one crop by the crop simulator 120 is affected by the other crop. The overall yield of the polyculture is obtained by combining the yield output of the first RNN 410 and the second RNN 420.

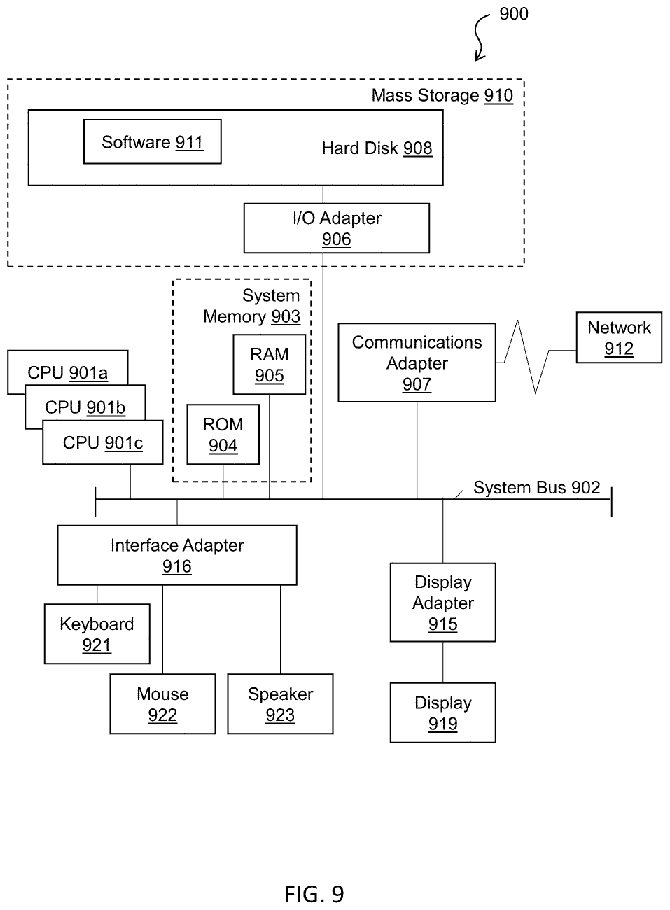

Turning now to FIG. 9, a computer system 900 is generally shown in accordance with an embodiment. The computer system 900 can be an electronic, computer framework comprising and/or employing any number and combination of computing devices and networks utilizing various communication technologies, as described herein. The computer system 900 can be easily scalable, extensible, and modular, with the ability to change to different services or reconfigure some features independently of others. The computer system 900 may be, for example, a server, desktop computer, laptop computer, tablet computer, or smartphone. In some examples, computer system 900 may be a cloud computing node. Computer system 900 may be described in the general context of computer system executable instructions, such as program modules, being executed by a computer system. Generally, program modules may include routines, programs, objects, components, logic, data structures, and so on that perform particular tasks or implement particular abstract data types. Computer system 900 may be practiced in distributed cloud computing environments where tasks are performed by remote processing devices that are linked through a communications network. In a distributed cloud computing environment, program modules may be located in both local and remote computer system storage media, including memory storage devices.

The computer system 900 can facilitate implementing the neural network system 400 in one or more embodiments of the present invention. Alternatively, or in addition, the computer system 900 can facilitate implementing each node 200. The computer system 900, in one or more embodiments of the present invention, can also execute the method 800 described herein.

As shown in FIG. 9, the computer system 900 has one or more central processing units (CPU(s)) 901a, 901b, 901c, etc. (collectively or generically referred to as processor(s) 901). The processors 901 can be a single-core processor, multi-core processor, computing cluster, or any number of other configurations. The processors 901, also referred to as processing circuits, are coupled via a system bus 902 to system memory 903 and various other components. The system memory 903 can include a read only memory (ROM) 904 and a random access memory (RAM) 905. The ROM 904 is coupled to the system bus 902 and may include a basic input/output system (BIOS), which controls certain basic functions of the computer system 900. The RAM is read-write memory coupled to the system bus 902 for use by the processors 901. The system memory 903 provides temporary memory space for operations of said instructions during operation. The system memory 903 can include random access memory (RAM), read only memory, flash memory, or any other suitable memory systems.

The computer system 900 comprises an input/output (I/O) adapter 906 and a communications adapter 907 coupled to the system bus 902. The I/O adapter 906 may be a small computer system interface (SCSI) adapter that communicates with a hard disk 908 and/or any other similar component. The I/O adapter 906 and the hard disk 908 are collectively referred to herein as a mass storage 910.

Software 911 for execution on the computer system 900 may be stored in the mass storage 910. The mass storage 910 is an example of a tangible storage medium readable by the processors 901, where the software 911 is stored as instructions for execution by the processors 901 to cause the computer system 900 to operate, such as is described hereinbelow with respect to the various Figures. Examples of computer program product and the execution of such instruction is discussed herein in more detail. The communications adapter 907 interconnects the system bus 902 with a network 912, which may be an outside network, enabling the computer system 900 to communicate with other such systems. In one embodiment, a portion of the system memory 903 and the mass storage 910 collectively store an operating system, which may be any appropriate operating system, such as the z/OS or AIX operating system from IBM Corporation, to coordinate the functions of the various components shown in FIG. 9.

Additional input/output devices are shown as connected to the system bus 902 via a display adapter 915 and an interface adapter 916 and. In one embodiment, the adapters 906, 907, 915, and 916 may be connected to one or more I/O buses that are connected to the system bus 902 via an intermediate bus bridge (not shown). A display 919 (e.g., a screen or a display monitor) is connected to the system bus 902 by a display adapter 915, which may include a graphics controller to improve the performance of graphics intensive applications and a video controller. A keyboard 921, a mouse 922, a speaker 923, etc. can be interconnected to the system bus 902 via the interface adapter 916, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 9, the computer system 900 includes processing capability in the form of the processors 901, and, storage capability including the system memory 903 and the mass storage 910, input means such as the keyboard 921 and the mouse 922, and output capability including the speaker 923 and the display 919.

In some embodiments, the communications adapter 907 can transmit data using any suitable interface or protocol, such as the internet small computer system interface, among others. The network 912 may be a cellular network, a radio network, a wide area network (WAN), a local area network (LAN), or the Internet, among others. An external computing device may connect to the computer system 900 through the network 912. In some examples, an external computing device may be an external webserver or a cloud computing node.

It is to be understood that the block diagram of FIG. 9 is not intended to indicate that the computer system 900 is to include all of the components shown in FIG. 9. Rather, the computer system 900 can include any appropriate fewer or additional components not illustrated in FIG. 9 (e.g., additional memory components, embedded controllers, modules, additional network interfaces, etc.). Further, the embodiments described herein with respect to computer system 900 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Embodiments of the present invention provide system and associated methods for estimating crop yield in mixed crop (polyculture) scenario by simulating effect of a crop with another by an interaction layer. The interaction layer captures interaction of one crop with another, and in turn helps to captures the impact of one crop on another. This is achieved by using RNN systems in one or more embodiments of the present invention, because data for polyculture setting may be limited. For every crop, embodiments of the present invention use pre-trained RNN models to estimate the yield of the crop. The outputs from each crop RNN are fed back to not only its own RNN but to RNN of other crops. The interaction layer provides an additional cell for every RNN, the cell captures the interaction of a crop with another. The additional cell in an RNN at time t+1 modifies the output from the time t of the RNN with the outputs of RNNs of another crops at time t. Individual weights for each crop have already been learned by the individual crop RNNs and the interaction layer facilitates further tuning these weights. The weights for the interaction layer, which is can be an RNN itself, are learned by a training process. Embodiments of the present invention can also provide a harvest date advisory for each crop in a polyculture environment by analyzing the temporal profile of simulated crop yields.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source-code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

What is claimed is:

1. A computer-implemented method for providing feedback between separate neural networks, the method comprising:
configuring a plurality of neural networks, each neural network in the plurality of neural networks predicting crop yield for a respective crop from a plurality of crops based on a plurality of crop growth time series that comprises a crop growth time series for each respective crop, the plurality of crops being grown in a polyculture;
generating, by a crop simulator, the plurality of crop growth time series based on application rates of farm inputs that are provided to the crop simulator;
determining a predicted crop yield of the polyculture at a timepoint after a predetermined duration by iteratively performing for a predetermined number of times:
computing, by an interaction layer, changes to the application rates of farm inputs based on the plurality of crop growth time series;
applying the changes to the application rates of farm inputs and recomputing the plurality of crop growth time series, the application rates of farm inputs causing an interaction between the crop growth time series for each respective crop;
predicting the crop yield for each respective crop by the plurality of neural networks using the plurality of crop growth time series that are recomputed causing an interaction between the crop yields; and
outputting the predicted crop yield of the polyculture by combining the crop yield predictions from each of the plurality of neural networks.

2. The computer-implemented method of claim 1, wherein the interaction layer comprises another neural network.

3. The computer-implemented method of claim 2, wherein the interaction layer comprises a recurrent neural network.

4. The computer-implemented method of claim 1, wherein each neural network in the plurality of neural networks comprises a recurrent neural network.

5. The computer-implemented method of claim 1, wherein the predetermined duration is divided into a plurality of time periods, wherein the crop simulator generates the crop growth time series for a time period, and the interaction layer computes the changes to the application rates of farm inputs for a sequentially subsequent time period.

6. The computer-implemented method of claim 1, wherein the farm inputs include at least one of water, fertilizer, and pesticide.

7. The computer-implemented method of claim 1 further comprising, outputting a harvest date advisory for each crop from the plurality of crops.

8. A system comprising:
a memory device; and
one or more processing units coupled with the memory device, the one or more processing units configured to perform a method comprising:
configuring a plurality of neural networks, each neural network in the plurality of neural networks predicting crop yield for a respective crop from a plurality of crops based on a plurality of crop growth time series that comprises a crop growth time series for each respective crop, the plurality of crops being grown in a polyculture;
generating, by a crop simulator, the plurality of crop growth time series based on application rates of farm inputs that are provided to the crop simulator;
determining a predicted crop yield of the polyculture at a timepoint after a predetermined duration by iteratively performing for a predetermined number of times:
computing, by an interaction layer, changes to the application rates of farm inputs based on the plurality of crop growth time series;
applying the changes to the application rates of farm inputs and recomputing the plurality of crop growth time series, the application rates of farm inputs causing an interaction between the crop growth time series for each respective crop;
predicting the crop yield for each respective crop by the plurality of neural networks using the plurality of crop growth time series that are recomputed causing an interaction between the crop yields; and
outputting the predicted crop yield of the polyculture by combining the crop yield predictions from each of the plurality of neural networks.

9. The system of claim 8, wherein the interaction layer comprises another neural network.

10. The system of claim 9, wherein the interaction layer comprises a recurrent neural network.

11. The system of claim 8, wherein each neural network in the plurality of neural networks comprises a recurrent neural network.

12. The system of claim 8, wherein the predetermined duration is divided into a plurality of time periods, wherein the crop simulator generates the crop growth time series for a time period, and the interaction layer computes the changes to the application rates of farm inputs for a sequentially subsequent time period.

13. The system of claim 8, wherein the farm inputs include at least one of water, fertilizer, and pesticide.

14. The system of claim 8 further comprising, outputting a harvest date advisory for each crop from the plurality of crops.

15. A computer program product comprising a computer-readable storage media having computer-executable instructions stored thereupon, which when executed by a processor cause the processor to perform a method comprising:
configuring a plurality of neural networks, each neural network in the plurality of neural networks predicting crop yield for a respective crop from a plurality of crops based on a plurality of crop growth time series that comprises a crop growth time series for each respective crop, the plurality of crops being grown in a polyculture;
generating, by a crop simulator, the plurality of crop growth time series based on application rates of farm inputs that are provided to the crop simulator;
determining a predicted crop yield of the polyculture at a timepoint after a predetermined duration by iteratively performing for a predetermined number of times:
computing, by an interaction layer, changes to the application rates of farm inputs based on the plurality of crop growth time series;
applying the changes to the application rates of farm inputs and recomputing the plurality of crop growth time series, the application rates of farm inputs causing an interaction between the crop growth time series for each respective crop;
predicting the crop yield for each respective crop by the plurality of neural networks using the plurality of crop growth time series that are recomputed causing an interaction between the crop yields; and
outputting the predicted crop yield of the polyculture by combining the crop yield predictions from each of the plurality of neural networks.

16. The computer program product of claim 15, wherein the interaction layer comprises another recurrent neural network.

17. The computer program product of claim 15, wherein each neural network in the plurality of neural networks comprises a recurrent neural network.

18. The computer program product of claim 15, wherein the predetermined duration is divided into a plurality of time periods, wherein the crop simulator generates the crop growth time series for a time period, and the interaction layer computes the changes to the application rates of farm inputs for a sequentially subsequent time period.

19. The computer program product of claim 15, wherein the farm inputs include at least one of water, fertilizer, and pesticide.

20. The computer program product of claim 15 further comprising, outputting a harvest date advisory for each crop from the plurality of crops.
